(19) United States
(12) Patent Application Publication
(10) Pub. No.: US 2026/0288745 A1
(43) Pub. Date: Sep. 24, 2026

(54) Computer Implemented Data Structure and Architecture for Managing Two Separate Data Stores and an Associated Method

(71) Applicant: PosAm, spol. s.r.o., Bratislava (SK)

(72) Inventors: Marián Marek, Bratislava (SK); Tomáš Kysela, Vinicné (SK); Miroslav Rúcka, Žilina (SK); Peter Ivan, Bratislava (SK); Václav Bárta, Bratislava (SK); Tomáš Mihalovic, Bratislava (SK)

(21) Appl. No.: 19/087,210

(22) Filed: Mar. 21, 2025

(51) Int. Cl. G06F 16/25

(52) U.S. Cl. CPC G06F 16/252

(57) ABSTRACT

The present disclosure provides a computer implemented data structure and architecture for managing separate data stores and processing data for monitoring and controlling a system in real time. The architecture comprises a first architecture portion for managing a first data store containing mutable data, and a second architecture portion for managing a second data store containing immutable data. The first architecture portion includes a first data layer, a first logic layer, and a first application programming interface layer. The first data store contains reference attributes reflecting current system variable states and process parameters reflecting ongoing processes. The first logic layer requests data from both stores, processes the data to determine updated values or actions, and stores or outputs the results. The architecture enables efficient management of current and historical system data for real-time monitoring and control.

### TECHNICAL FIELD

The present invention is in the field of data structures and/or computer implemented architectures. More specifically, the present invention is in the field of such systems for the managing of real-world systems that generate large quantities of data, wherein the management of such systems is essential to the reliable operation of the systems.

### BACKGROUND

For real-world systems such as civil-engineering including car-parking systems, public transport networks, with multiple users, high number of interactions and a complex pattern of use, a large quantity of data is generated. At present it is estimated that in any information system operating over a significant period of time (e.g. more than a year), the ratio of stored present data (mutable data that is frequently accessed and essential for ongoing usage and further consist of reference data representing current state of the system and process data representing ongoing processing in the system) to stored historic data (past immutable data that is rarely accessed by active usage and is represented by data of finished processes) typically approximates to 1:10. Historic data tends to accumulate approximately ten times faster than present data. The speed of access (both reading and writing) to present data fundamentally determines the overall processing speed and performance of the system. This can be of great importance to some applications.

It is a well-established observation that conventional, state-of-the-art information systems store both present and historical data in a single data store or database. This architecture leads to historical data significantly degrading the system's performance in various ways (essentially the duration of database operations lengthens under the same load and with the same available system resources). It is typically addressed by using distributed system techniques, which, however, come at the cost of increased resource consumption (e.g., for data synchronization and replication). Moreover, both monolithic or current modular systems (designed for example with one of the most popular methodologies for modular systems-Domain Driven Design, or DDD) often require the creation and maintenance of multiple additional copies of significant parts of data for purposes such as reporting or batch post-processing. This practice further increases storage requirements and computing resource consumption.

It is the aim of the present application to provide a more modularized approach to such computer implemented data structure to achieve a data volume reduction in present data, processing performance optimization, a security improvement, and more reliable usage should an error occur in one portion of the system.

One aim is that as a different approach to storing and using present and historic data is employed, the performance of the system is increased and overall (when counting also reporting and/or batch-processing and/or backup and archiving) data volume that the system processes and stores is also reduced. This lowers demand for storage systems and the database's capacity.

Another aim is for modules to be optimized for specific tasks resulting in reduction of ineffective use of the computing capacity and of the overall hardware requirements.

For further aims, it is advantageous (but not necessary) to match modularity of data structure with modularity on the level of computer implemented information system architecture-using reference module(s) for reference data, process module(s) for process data and historical data services module for data of finished processes.

A further aim is therefore for a precise modular computer implemented data structure and computer implemented architecture to contribute to improved security by providing isolation and control. Each module can be isolated from other modules, which means that an error or security issue in one module will not unnecessarily threaten the entire system. Another advantage of the presented architecture regarding security is its ability to prevent successful ransomware attacks.

Yet a further aim of the system is for simplified updates and corrections for more reliable usage. The modules can then be updated or corrected independently which allows to counteract any security threats and vulnerabilities faster.

The present application aims to improve at least one of these parameters of such a system.

### SUMMARY OF INVENTION

Aspects of the invention are set out in the independent claim. Optional features are set out in the dependent claims.

In accordance with a aspects of invention, there is provided a computer implemented data structure and architecture for managing two separate data stores, and for processing this data for the purpose of monitoring and controlling a system in real time based on this data, wherein the first data store comprises mutable data, and the second data store comprises immutable data, the data structure and architecture comprising: a first architecture portion configured for management of the first data store, and a second architecture portion configured for management of the second data store, wherein the first architecture portion and second architecture portion are functionally linked so that immutable data is configured to be provided to the first architecture portion when requested; wherein the first architecture portion comprises a first data layer comprising the first data store, a first logic layer, and a first application programming interface layer; wherein the first data store comprises one or more reference attributes whose values reflect the current state of variables within the system; wherein the first data store further comprises one or more process parameters whose values reflect ongoing processes within the system; wherein both the reference attributes and the process parameters are mutable data; wherein the first architecture portion is configured to output process parameter values of complete processes to the second data store; wherein the first logic layer is configured to request mutable data from the first data store, and immutable data from the second architecture portion; wherein the first logic layer is configured to process this requested and/or received data to determine updated values for reference attributes, and/or process parameters, and/or new actions of the system, and wherein this processing is configured to be parameterised on the basis of the one or more process parameters; wherein the first architecture portion is then configured to: i) store the updated values for reference attributes and/or process parameters in the first data store; and/or ii) output updated values of reference attributes and or process parameters and/or new actions of the system to the first application programming interface layer. The advantages of this system are numerous. Firstly, security is improved in a number of ways. The use of two separate hemispheres, one for mutable data such as current data that is in present usage, and one for immutable data representing historic data, means that these two domains are entirely separate from one another. One hemisphere can be updated, corrected or otherwise taken out of service for a brief time without affecting the other. This can be an advantage to prevent successful ransomware attacks-when combined with write-only storage capability for the datastore containing historical data. Historical data cannot be encrypted by an attacker and while entire system can be restored from historical data with reasonable recovery point objective(s), this renders any ransomware attack ineffective. Further, an error would not affect the other portion due to this modularisation. This also makes the indexes in these data stores slimmer and therefore data writes and data reads can be performed faster and require less energy to do so. Indeed, the concept of having immutable and mutable data is heavily advantageous as it means that historic data cannot be changed whilst live data is changed to update and reflect the real-world system. This also allows specialisation of the indexes of each data store with indexes optimized for modification and searching in changing mutable data as opposed to specialized indexes for only adding and searching in fixed immutable data.

It is also common practice to have a back-up at periodic intervals for the present mutable data. Having this data which represents only a fraction ( 1/10) of the whole data in a separate data store allows for significantly faster backup to be performed. Facts (historic immutable data) can be backed up and archived using a purely additive (append-only) approach (instead of a series of full or differential backups), which speeds up the backup or archiving process and requires less storage space for the backups and archives. The backup/archiving of both the above-mentioned databases can be parallelized, speeding up the backup or archiving at the system-wide level. Further, having only a fraction of the whole data as mutable data and separation of this subset of data into separate (much smaller) data store, delays the negative effects of data scaling. Furthermore, partitioning mutable data into disjoint data stores per unit of functionality naturally supports scalability without additional penalties when working with data. Additionally, any known data scaling technique (data replication, sharding) can be applied, and the partitioning data stores does not reduce its additional effect in any way.

In a conventional, state of the art information system, multiple copies of all data are created and maintained-for each specific usage. The first (source) copy is data in the original (large) database and serves to aid transactional processing in the system. The second copy is created for system backup purpose. The third copy is usually created as separate data source for reporting-so that reporting procedures do not slow down transactional processing. For the same reason, the fourth copy is typically created if intensive batch post-processing is needed. In the present case, due to the specific design of process instance parameters and their values (that consistently record all relevant information for each processing) and due to the rule, that all finished process instances become immutable facts and these immutable facts are moved into the historic data store (database)-only a single copy of historic data (facts) is needed that can serve all purposes (on-line transactional processing, reporting, batch post-processing) without interference between each other. A single copy means less storage and less CPU cycles for creation and maintenance (synchronization) of data store(s).

Optionally, the first architecture portion comprises a first section relating to reference data, and a second section relating to process data that is still relevant to ongoing processes within the system. This allows for further modularisation. This means that only necessary data is extracted and assembled which results in shorter extraction times.

Optionally, the first section of the first architecture portion comprises a reference data layer, a reference logic layer and the first application programming interface layer, and wherein the second section of the first architecture portion comprises a process data layer, a process logic layer, and the first application programming interface layer. This further enhances modularisation between reference data and process data. This allows operations involving only one such data type to be wholly independent of the other.

Optionally, the first data layer comprises the reference data layer and the process data layer, and/or wherein the first logic layer comprises the reference logic layer and the process logic layer.

Optionally, the first logic layer is configured to receive input data, representing inputs from users or external systems, from the first application programming interface layer. This enables the real-world system/user input to directly modify the mutable data within the system.

Optionally, the second architecture portion comprises a second data layer comprising the second data store, a second logic layer and a second application programming interface layer.

Optionally, the first logic layer comprises a reference module, optionally wherein the reference logic layer comprises the reference module. The reference module enables the reading and writing of reference attributes in the first data layer, for example in response to updated informal provided by the real-world system.

Optionally, the first logic layer and/or the process logic layer comprises a process module. This enables the process data to be read and written from the logic layer.

Optionally, the reference module is configured to request one or more reference attributes from the first data layer, optionally from the reference data layer. This enables the real-world system/user input to directly modify the mutable data within the system.

Optionally, the reference module is configured to provide reference values to the process module when requested. Therefore, where the process module is configured to determine a value of a process on the basis of a reference attribute (e.g., a mean over a set time period, or the variance of a value, or any other determination based on one or more reference attributes) this data is provided from the reference module to the process module. This increases modularity of the system by imposing restrictions of the reading of reference attributes, and only once this data is read can it then be disseminated.

Optionally, the reference module is configured to provide reference attributes to the first application programming interface layer when requested. This increases modularity of the system by imposing restrictions of the reading of reference attributes, and only once this data is read can it then be disseminated.

Optionally, reference module is configured to receive updated reference attributes from the process module, and is further configured to send these to the first data layer, optionally the reference data layer, to update the reference attributes stored therein. This shows that the reference attributes stored in the data layer only communicate with the reference modules (and in some embodiments only with those in the same unit of functionality) to further increase modularity.

Optionally, the second data store comprises an historic process parameter value, optionally wherein a process parameter value is sent to the second data store when the process parameter value is no longer associated with an active process, and therein said process value becomes a historic process parameter value. Advantageously this provides a method for updating the historic database, and for modularising the current and historic databases so that they are separate form one another.

Optionally, the second data layer further comprises a reporting database, wherein the reporting database receives historic process parameter values from the second data store. This may enable the historic data to be passed to the user or external system as required.

Optionally, the second logic layer comprises a reporting module, wherein the reporting module is configured to receive reports from the reporting database, and is configured to provide reports to the second application programming interface layer. This may enable the historic data to be passed to the user or external system as required.

Optionally, the second logic layer comprises a historical data services module, wherein the historical data services module is configured to receive historic process parameter values from the second data store.

Optionally, the historical data services module is configured to provide historic process parameter values from the second data store to the process module when requested. This enables a determination of a current parameter on the basis of an historic value. For example, where it is necessary to compare a current value with an historic value to determine change over time this may be of use.

Optionally, the historical data services module is configured to provide the second application programming interface layer with historic process parameter values.

Optionally, the process module is configured to receive process parameter values from the first data layer, optionally from the process data layer. This enables increased modularity of the system.

Optionally, the process module is configured to receive reference attributes from the reference module. This may enable direct communication from the reference module to the process module in some embodiments for efficiency of communication.

Optionally, the process module is configured to receive historic process parameter values from the historical data services module and/or directly from the second data store.

Optionally, the process module is configured to receive input data, representing inputs from users or external systems, from the first application programming interface layer. This may allow the real-world system and/or a user input to affect a determination by the process module.

Optionally, the process module is configured to send the received data to a second process module; and/or wherein the second process module is configured to request data from the first process module. This may allow for the modularity and security of the system to be increased further. Data may be sent to a first process module and the only provided to specific second process modules.

Optionally, the process module is configured to determine from requested and or received data new values for reference attributes and/or process parameters and/or next actions and to provide these to the first application programming interface layer. This may therefore provide an output to the real-world system. This may provide an instruction as to how the system may be operated.

Optionally, a reference attribute corresponds to a value of one of: a product, a measurement, or a quantity variable, in the system monitored and controlled by the computer.

Optionally, a report is an aggregated view of the historic process parameter values.

Optionally, the process module is configured to determine updated reference attributes and send these to the reference module, and/or wherein the process module is configured to determine updated process parameter values and send these to the first data layer or process data layer, optionally wherein the reference module is the reference module from which the reference value originated. This may enable the modularity of the system to be increased.

Optionally, the process module further comprises internal values which store new data derived from data provided to the process module such as reference attributes from a reference module and/or process parameter from a process module, and said internal value in turn is configured to be used by the process module to determine the new/updated reference attribute and/or action. This may allow a process module to hold several values over a period of time. For example, where a reference value relates to an attribute of a real-world system that changes every period of time it may be necessary to determine a rolling average of the variable. The internal values may store the reference attributes over that time period for ease of computation.

Optionally, a plurality of process modules and a plurality of reference modules are split into units of functionality. This may be highly advantageous especially for increased security, reliability and modularity. The units of functionality may prohibit access to reference attributes or process parameters to only selected reference modules and/or process modules. This means that only certain modules can read/write certain data. This means that should an error occur it can be highly localised and so not cause larger system issues. Moreover, it means that the security of the system is inherently more robust. It also reduces the number of times that data may be replicated in the system, and therefore make the system more efficient.

Optionally, each unit of functionality of the first architecture portion interacts separately with the second architecture portion. This may provide this same modularity for the relationship between the first architecture portion and the second architecture portion. This may preserve this increased security through all means of accessing the data.

Optionally, each unit of functionality of the first architecture portion comprises a segregated portion of the first architecture portion. This may mean that each unit of functionality is functionally distinct from the others.

Optionally, each unit of functionality is configured to request/read data from another unit of functionality, and/or wherein one unit of functionality can only read data from another unit of functionality, optionally wherein a process module in first unit of functionality can only write/update a value of a reference attribute associated with a reference module in the same unit of functionality. These optional features may in some embodiments encapsulate rules for the dissemination of data through the system to ensure that modularity is preserved.

Optionally, the first architecture portion is configured to manage present data and recently past data that represents ongoing activities within the system. This sets out that mutable data may comprise data that reflects the present (or very recent past) state of the system, whilst immutable data represents historic data that does not reflect the current state of the real world system.

Optionally, wherein the reference module is passive and reactively handles requests to read and write reference attributes, optionally wherein the reference module does not initiate behaviour.

Optionally, the mutable data comprises present data, and the immutable data comprises past data, optionally wherein present data comprises both present data, and recent past data still reflecting ongoing activities within the system.

### BRIEF DESCRIPTION OF THE DRAWINGS

The detailed description is set forth below with reference to the accompanying figures. In the figures, the left-most digit(s) of a reference number identifies the figure in which the reference number first appears. The use of the same reference numbers in different figures indicates similar or identical items. The systems depicted in the accompanying figures are not to scale and components within the figures may be depicted not to scale with each other.

FIG. 1 shows a representation of the data structure and architecture of an embodiment of the present invention. The focus of this figure is the movement of data between the layers and architecture portions.

FIG. 2 shows the data structure of some embodiments of FIG. 1 in more detail with further structure of the second architecture portion shown.

FIG. 3 shows a representation of the data structure and architecture of an embodiment of the present invention. This focusses on the movement of data between process modules and/or units of functionality.

FIG. 4 shows the interaction of two linked units of functionality.

FIG. 5 serves as an illustration to aid in understanding the structure of concepts for the unit of functionality.

FIG. 6 details the interactions between units of functionality and the second architecture portion.

FIG. 7 shows an exemplary unit of functionality for use in management of parking permits FP in a car parking system. This system may be used for any application and this is simply an example of one usage.

FIG. 8 shows generic functionality of process module as a simple flow chart.

### DETAILED DESCRIPTION

There is described and shown a computer implemented data structure and architecture for managing two separate data stores, and for processing this data for the purpose of monitoring and controlling a system in real time based on this data, wherein the first data store comprises mutable data, and the second data store comprises immutable data, the data structure and architecture comprising: a first architecture portion configured for management of the first data store, and a second architecture portion configured for management of the second data store, wherein the first architecture portion and second architecture portion are functionally linked so that immutable data is configured to be provided to the first architecture portion when requested; wherein the first architecture portion comprises a first data layer comprising the first data store, a first logic layer, and a first application programming interface layer; wherein the first data store comprises one or more reference attributes whose values reflect the current state of variables within the system; wherein the first data store further comprises one or more process parameters whose values reflect ongoing processes within the system; wherein both the reference attributes and the process parameters are mutable data; wherein the first architecture portion is configured to output process parameter values of complete processes to the second data store; wherein the first logic layer is configured to request mutable data from the first data store, and immutable data from the second architecture portion; wherein the first logic layer is configured to process this requested and/or received data to determine updated values for reference attributes, and/or process parameters, and/or new actions of the system, and wherein this processing is configured to be parameterised on the basis of the one or more process parameters; wherein the first architecture portion is then configured to: i) store the updated values for reference attributes and/or process parameters in the first data store; and/or ii) output updated values of reference attributes and or process parameters and/or new actions of the system to the first application programming interface layer.

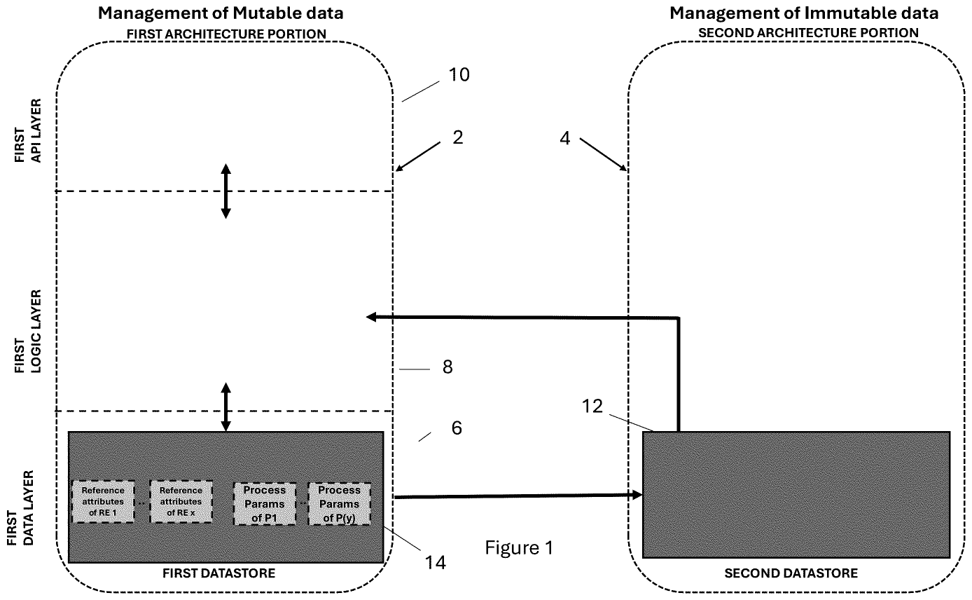

FIG. 1 shows a data structure and computer architecture. This is for the management of a real-world system such as a public transport network, car park, or other such physical or electronic means. FIG. 1 shows that this structure is split into a first architecture portion 2 and a second architecture portion 4. The first architecture portion 2 concerns the management of mutable data. This is data that can be changed. This data typically relates to data that represents a variable or measurement in the real-world system in its current value (or a very recent value in some instances). The second architecture portion 4 is for the management of immutable data. This is data that cannot be changed. This data typically corresponds with past data such as historic values of the system and its variables in the past. In most instances historic data comprises the majority of the data in the system (at least once the system has been running for some time). Often the amount of immutable data outnumbers the mutable data by a ratio of at least 10:1. Typically, immutable data needs to be accessed with less frequency compared to the mutable data. It is therefore an advantage of the present system that the storage of immutable data is separated from the storage of mutable data to make ease of access to the most frequently referred to mutable data significantly more efficient.

The first architecture portion comprises a first data layer 6, a first logic layer 8, and a first API (application programming interface) 10. The first API 10 allows for interaction with either a user (not shown) or the physical real-world system such that data, instructions, or the like can be received or sent. The first logic layer 8 is configured to perform any processing tasks required in the first architecture portion 2 including receiving inputs from users or external systems from the API 10. The first data layer is configured to store the mutable data.

The second architecture portion 4 may comprise significantly more structures than is shown herein. However, for the most basic embodiment it may comprise just a second data store 12. The second data store 12 is configured to store the immutable data. In some embodiments just complete process parameters that no longer reflect an ongoing activity of the system are sent to and stored in the second data store 12. In other embodiments both complete process parameters, and changes on reference attributes are sent to and stored in the second data store.

Data from the first data layer 6 may be passed to the first logic layer 8. Data from the second data store 12 (or indeed from any portion of the second architecture portion 4) may be passed to the first logic layer 8. Data passed to the first logic layer 8 may be processed, or simply relayed. Data from the first logic layer 8 may be sent to the first API layer 10 for sending to a user or external real-world system.

Data from the first API layer 10 (such as new updated data, or a request) may be sent to the first logic layer 8. Updated or new data either sent to or determined in the first logic layer 8 may be sent to the first data layer 6 for storage. Once process data in the first architecture portion 2 is no longer representative of the value of a variable or otherwise representative of the real-world system that data is then sent to the second data store 12 in the second architecture portion 4. At this time the data becomes immutable data and can no longer be changed.

The first data store 14 comprises (albeit these features are optional in many embodiments) one or more data store elements for storing reference attributes and one or more data store elements for storing process parameters. A reference attribute corresponds to a value of one of: a product, a measurement, or a quantity variable, in the system monitored and controlled by the computer. A process parameter is data that relates to an ongoing activity of the system. In this way a reference attribute is a record of a distinct value of a thing (in the same way that a noun is a word to describe an object), whilst a process parameter is data that describes an ongoing activity (in the same way that a verb sets out an action that is being undertaken).

The first logic layer 8 is configured to process the data (whether that be in the form of process parameters or reference attributes from the first data store 14, or data from the second data store 12). The first data layer 6 may determine updated reference attributes and/or process parameters, or new actions for the system, or information to be displayed to a user (not shown). Based on this determination the first architecture portion 2 then either stores the updated values for the reference attributes and/or process parameters in the first data store 14, or outputs the new actions or updated values, or information to the first API layer 10 to disseminate to the external system or user.

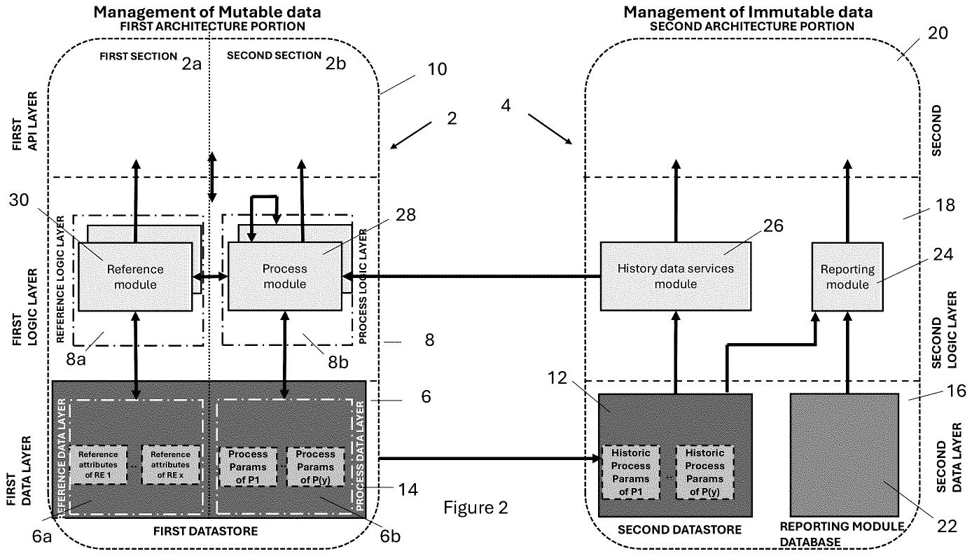

FIG. 2 is similar to FIG. 1—however more structure is shown in this second embodiment. In this second embodiment the second architecture portion 4 comprises a second data layer 16, a second logic layer 18 and a second API layer 20.

The second data store 12 of FIG. 1 is shown stored in the second data layer 16. This is shown as storing the completed historic process parameters (including new values for reference attributes) sent to the second data store 12 from the first data store.

Also shown in the second data layer 16 is a reporting module database 22 for compiling reports to a reporting module 24. This is optional and may be omitted in some embodiments. In some embodiments the reporting module 24 may be directly connected to the second data store 12. The reporting module 24 may further provide said reports to the second API layer 20.

The second logic 18 layer of the second architecture portion 4 comprises a historical data services module 26. This may be configured to request historic data (or historic process parameters) from the second data store 12 and to pass this data to one or more process modules 28 of the first architecture portion 2. The arrow shows the information being sent in one direction, however requests for data may be sent from the process modules 28 to the historical data services module 26 in the other direction (not shown). The historical data services module 26 may also send historic data (or historic process parameters) to the second API layer 20.

The reporting module 24 may compile and/or send reports from the reporting module database 22 to the second API layer 20.

The second API 20 layer allows a user or external real-world system to access the historic data as needed.

FIG. 2 also shows additional structure in the first architecture portion 2. Whilst in some embodiments both the additional structure shown in FIG. 2 in the first architecture portion 2 and the second architecture portion 4 are present there may be embodiments in which only the additional structure of one portion is present. The features of each architecture portion are separable from one another and may be used by the person skilled in the art as required.

In FIG. 2 the first architecture portion 2 is split into a first section 2a and a second section 2b. The first section may relate to reference attributes and the second section may relate to process parameters. This may create further modularisation within the system.

In this embodiment, the first data store comprises a reference data layer 6a for storing the reference attributes, and a process data layer 6b for storing the process parameters. The first logic layer 8 comprises a reference logic layer 8a comprising the reference modules 30 and a process logic layer 8b comprising the process modules. In this embodiment the reference data layer 6a communicates with the reference logic layer 8a. Further, in this embodiment the process data layers 6b communicate with the process modules 8b. The process data layer 6b does not communicate directly with the reference logic layer 8a and the reference data layer 6a does not communicate directly with the process logic layer 8b.

In this embodiment the reference logic layer 8a and the process logic layer 8b communicate. This is so that the process modules 28 can request reference attributes from the reference module 30. The reference module 30 then may access these reference attributes from the reference data layer 6a. The reference module 30 can then send these reference attributes to the process module 28. Once the process module 28 has performed the determination, if the reference attribute is to be updated the updated reference attribute will be sent from the process module 28 to the reference module 30 (or in some embodiments may also be sent to the first data layer or process data layer). The reference module 30 will then write the updated reference attribute into the reference data layer 6a. Said updates may be provided to the first API layer 10 from the process module 28. Further, the process module 28 is configured to receive input from the first API layer 10 and so users or external systems may provide the input data to make the desired changes to the reference attributes or changes in general to the process module 28.

Similarly, these reference attributes may also be provided to the API 10 by the reference module 30 (when requested). In some embodiments, and although not shown with an arrow, any updates to said reference attributes may be made by a user or external system and then relayed back to the reference module 30 and subsequently to the first data layer 6a.

Furthermore, it can be said that the function of the reference module 30 is passive and reactive. It relates to handling requests to read and write reference attributes with limited processing of these values. The reference module 30 does not initiate behaviour/processing in this sense. In this embodiment process modules 28 may also communicate with one another such that data is shared between process modules 28 as requested. This access may be limited in some embodiments to process modules 28 within the same unit of functionality or linked units of functionality however, this will be set out in greater detail below.

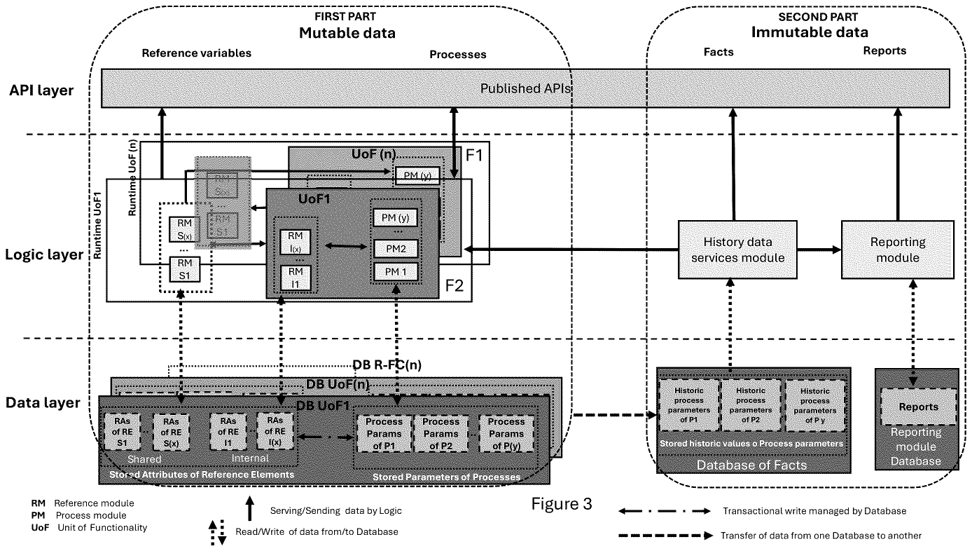

FIG. 3 shows another embodiment of the present system. In this embodiment the logic layer and the data layer are separated into parallel units of functionality F1, F2. In FIG. 3 each unit of functionality F1, F2 is shown as one or more process modules that interact with one or more reference modules in the logic layer, and one or more elements storing reference attributes and process parameters in the data layer.

The data stored within one unit of functionality can only be written or read by process modules and/or reference modules within the same unit of functionality. There may however be two categories of reference attributes. These may be categorised as “shared” or “internal”. Shared reference attributes may be typically shared for reading with all units of functionality. In exceptional cases, some shared reference attributes may be shared with some or all units of functionality also for writing (but typically not directly, but indirectly through respective process module(s)). Internal reference attributes may be internal to specific units of functionality. In some embodiments there may be no shared reference attributes. In some embodiments internal reference attributes can never be shared with other units of functionality.

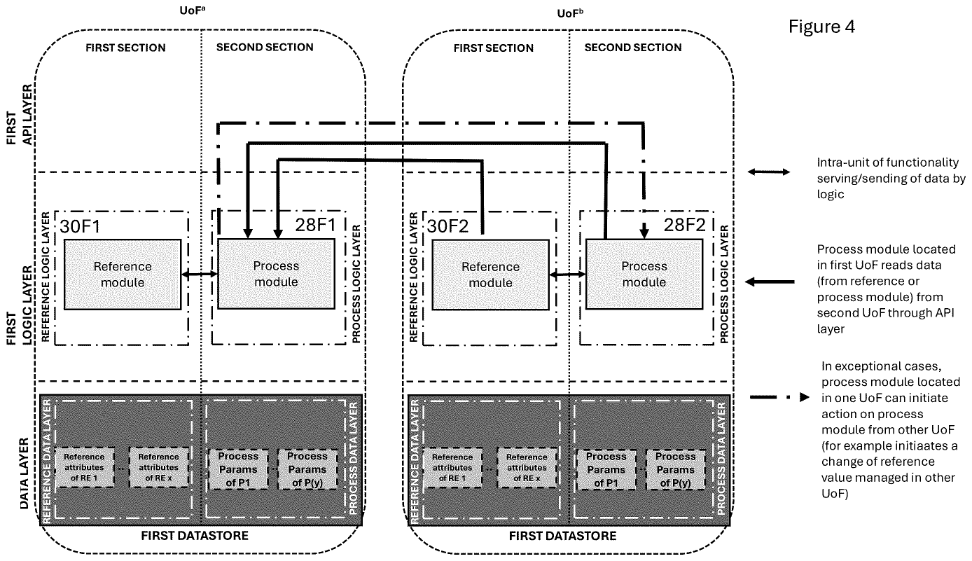

FIG. 4 shows the interaction between two units of functionality according to a first embodiment. In this embodiment, the process modules 28F1, 28F2 in each of the units of functionality communicate with the internal reference module in the respective unit of Functionality. On the top of that, the process module in first unit of functionality 28F1 reads reference values from reference module 30F2, or process parameter values from process module 28F2 located in second unit of functionality. FIG. 4 further illustrates an exceptional case, where process module 28F1 in the first unit of functionality can initiate action on the process module 28F2 from the second unit of functionality, typically to change some reference attribute variable in the second unit of functionality. All illustrated communication in the Figure is deliberately one sided, initiated from the first unit of functionality (and can be two-sided in some embodiments), as this one-sided communication allows units of functionality to be built enabling certain units of functionality to have greater access to more data, whilst others have significantly more limited access. This creates increased security in the system.

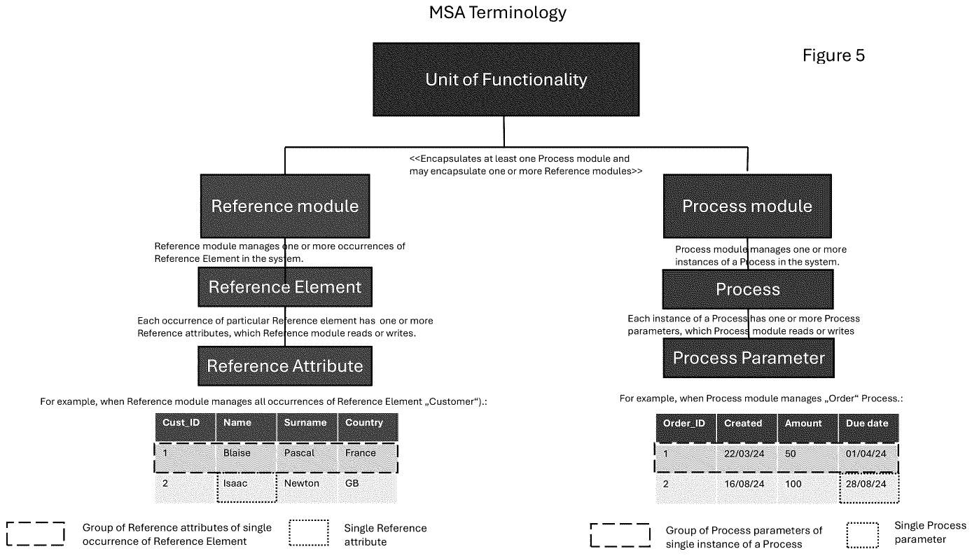

FIG. 5 serves as an illustration to aid in understanding the structure of concepts for the Unit of Functionality (UoF). This may comprise of one or more reference module(s) and of one or more process module(s). The unit of functionality further comprises some reference element(s) (within a reference data layer) which in turn store one reference attribute. An example of the reference attribute is given which shows user information. The unit of functionality also further comprises of one or more process(es) (which would be within a process data layer) and a process parameter stored in the process element. An example of the process parameter is given relating to dates/times that an item is used/needs to be used.

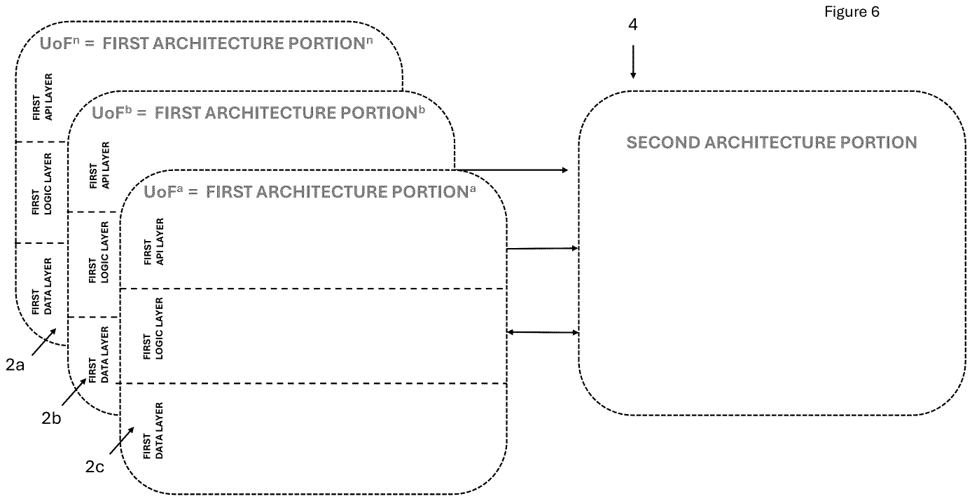

FIG. 6 shows that each of the units of functionality may communicate with the second architecture portion 4 independently. In this embodiment the second architecture portion 4 does not comprise units of functionality, and so there are as many communication paths as there are units of functionality in the first architecture portion 2a, 2b, 2c. In each case the first logic layer of each unit of functionality communicates with the second architecture portion. However, we do not exclude the possibility of further segmentation of the second architecture portion and thus having in some embodiments multiple Units of Historical Data on the side of the Second Architecture Portion.

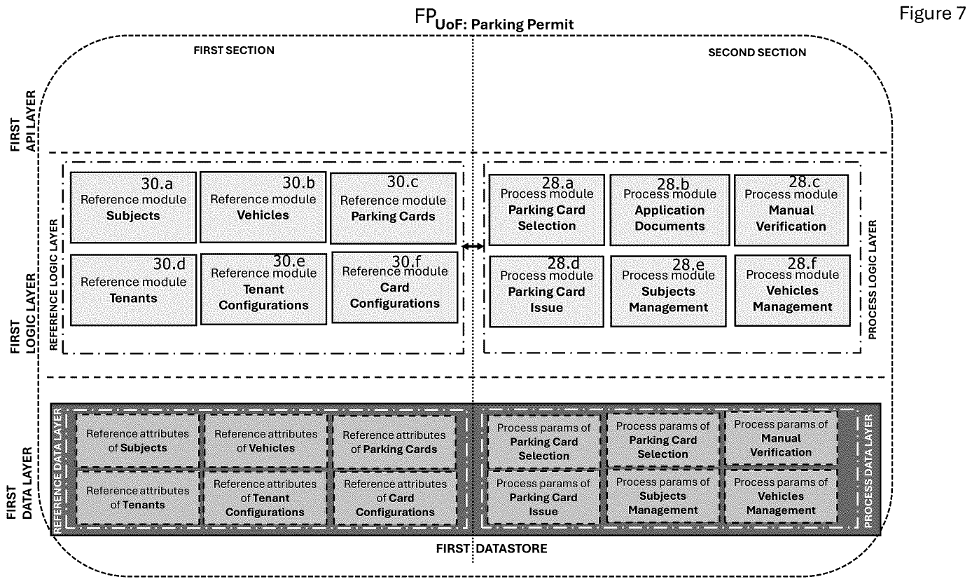

FIG. 7 shows an exemplary unit of functionality for use in management of parking permits FP in a car parking system. This has been necessarily simplified for illustration purposes, moreover the computational system and data structure may be used for the management of any external system.

If important information about the user is missing, such as their permanent or temporary residence or the vehicle they use, the user is redirected to the Subject Management module 28.e or the Vehicle Management module 28.f, where processes are initiated to complete this information. Depending on the tenant under which the user is entering the data, they may need to provide different levels and sets of information. The level of detail and scope of data required are influenced by reference attributes, which the modules retrieve from the reference modules Tenants 30.d and Tenant Configurations 30.e. The entered data (or data retrieved from external services) become parameter values of the initiated processes, and at the end of these processes, the relevant data are recorded as new values of reference attributes in the reference modules Subjects 30.a and Vehicles 30.b (data from finished processes are then moved to the second data layer).

In FIG. 7, the issuance of new parking permit starts when a user issues a request to select a parking card type (to be issued) via respective process module 28.a, where all types of cards available for the given tenant are offered. The configuration of available card types is retrieved as reference values from the attributes of the reference module 30.f, or it is determined based on the user's reference data (retrieved as needed from reference modules 30.a and 30.b). The data related to the selection of the card type and any additional information provided during the selection process are stored as process parameters. If some data require manual verification (which varies for each tenant according to the rules consulted from reference modules 30.d, 30.e, and 30.f), the process continues with the manual submission of supporting documents through module 28.b. The manually submitted documents become parameters of the process.

Next, a process is initiated via the corresponding module 28.c, where the submitted documents are verified. The result of the verification becomes a parameter of the manual verification process, and if necessary, the user's information may be updated through the relevant processes (28.e, 28.f) to avoid the need for manual document submission in the future. If no manual verification is required, the processes in modules 28.b and 28.c are skipped.

The process then proceeds with the issuance of the parking card itself. At the start, the system automatically verifies the entered data, calculates the price (using retrieved information from modules 30.e and 30.f), and the user proceeds with the payment. All data generated during the process become process parameters in process module 28.c. Finally, the issued card is assigned a unique number for the user and recorded as a reference attribute value in the Parking Cards module 30.c. (all data from finished processes are moved into second data layer). Reference values from this module are typically accessed by process modules from other functional units—for example, the parking authorization check process reads whether a vehicle is authorized to park, or the parking ticket purchase process retrieves parking card information to provide a discount for cardholders of a specific type.

It is noted that in this system there are technical advantages associated with the use of this unit of functionality and the system more generally. In particular the modularity of the system is maintained through this approach. This increases the security of the system and ensures that data may only be provided to authorised modules/users. This system as shown contains personal information. In many jurisdictions including the EU and the UK there are strict requirements on data protection and personal security, and this system means that this security is not compromised. Additionally, the system described above and applied to this example minimises the amount of data that is duplicated and saved in multiple places in the system. This means that the system is more efficient. This is especially true once the system has run for a great length of time and there is a large amount of historical data. This enables the system to run more efficiently, faster, and to consume less energy. Moreover, should the system need to be reconfigured in the future to add functionality the modularity of the system ensures that such changes are simplified and are significantly less likely to cause problems in other areas of a system (for example where this is one small part of a much larger system, such as a hotel chains booking software).

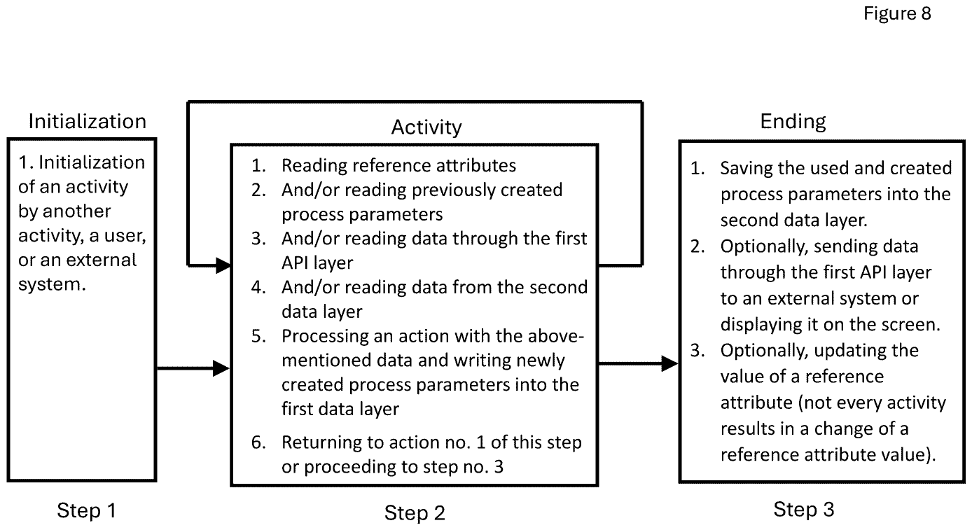

FIG. 8 shows various steps that may be carried out by a process module in architecture system set out above.

First step. In the first step, the activity initialization takes place. The first layer of logic can be activated by an internal timer within the first logic layer, through the first API layer from an external system, or by a user from the interface.

Second step. In the second step, multiple activities can be executed cyclically, with each consisting of several actions. These actions typically follow this sequence:

The first logic layer retrieves reference attributes from the first data layer through the reference module.

And/or the first logic layer retrieves previously created process parameters from the first data layer.

And/or the first logic layer retrieves data from an external system or user-entered data from the interface via the first API layer.

And/or the first logic layer retrieves historical data from the second data layer.

The first logic layer executes a function using the above data and then writes newly created process parameters into the first data layer.

The first logic layer ensures a return to action no. 1 of this step or proceeds to Third Step.

Third step. The completion of the activity consists of the following actions:

The first logic layer ensures the storage of used and created process parameters in the second data layer.

Optionally, the first logic layer sends the created process parameters to an external system or the interface via the first API layer.

Optionally, the first logic layer updates the reference attribute values through the reference module (not every activity leads to a change in a reference attribute value).

All of the above actions are always performed in the context of the given user.

### Example Clauses

1. A computer implemented data structure and architecture for managing two separate data stores, and for processing this data for the purpose of monitoring and controlling a system in real time based on this data, wherein the first data store comprises mutable data, and the second data store comprises immutable data, the data structure and architecture comprising: a first architecture portion configured for management of the first data store, and a second architecture portion configured for management of the second data store, wherein the first architecture portion and second architecture portion are functionally linked so that immutable data is configured to be provided to the first architecture portion when requested; wherein the first architecture portion comprises a first data layer comprising the first data store, a first logic layer, and a first application programming interface layer; wherein the first data store comprises one or more reference attributes whose values reflect the current state of variables within the system; wherein the first data store further comprises one or more process parameters whose values reflect ongoing processes within the system; wherein both the reference attributes and the process parameters are mutable data; wherein the first architecture portion is configured to output process parameter values of complete processes to the second data store; wherein the first logic layer is configured to request mutable data from the first data store, and immutable data from the second architecture portion; wherein the first logic layer is configured to process this requested and/or received data to determine updated values for reference attributes, and/or process parameters, and/or new actions of the system, and wherein this processing is configured to be parameterised on the basis of the one or more process parameters; wherein the first architecture portion is then configured to: i) store the updated values for reference attributes and/or process parameters in the first data store; and/or ii) output updated values of reference attributes and or process parameters and/or new actions of the system to the first application programming interface layer.
2. The computer implemented data structure and architecture of clause 1,wherein the first architecture portion comprises a first section relating to reference data, and a second section relating to process data that is still relevant to ongoing processes within the system.
3. The computer implemented data structure and architecture of clause 2,wherein the first section of the first architecture portion comprises a reference data layer, a reference logic layer and the first application programming interface layer, and wherein the second section of the first architecture portion comprises a process data layer, a process logic layer, and the first application programming interface layer.
4. The computer implemented data structure and architecture of any preceding clauses, wherein the first data layer comprises the reference data layer and the process data layer, and/or wherein the first logic layer comprises the reference logic layer and the process logic layer.
5. The computer implemented data structure and architecture of any preceding clause, wherein the first logic layer is configured to receive input data, representing inputs from users or external systems, from the first application programming interface layer.
6. The computer implemented data structure and architecture of any preceding clause, wherein the second architecture portion comprises a second data layer comprising the second data store, a second logic layer and a second application programming interface layer.
7. The computer implemented data structure and architecture of any preceding clause, wherein the first logic layer comprises a reference module, optionally wherein the reference logic layer comprises the reference module.
8. The computer implemented data structure and architecture of any preceding clause, wherein the first logic layer and/or the process logic layer comprises a process module.
9. The computer implemented data structure and architecture of clause 7, wherein the reference module is configured to request one or more reference attributes from the first data layer, optionally from the reference data layer.
10. The computer implemented data structure and architecture of clause 9, when dependent on clause 8, wherein the reference module is configured to provide reference values to the process module when requested.
11. The computer implemented data structure and architecture of clause 9 or 10, wherein the reference module is configured to provide reference attributes to the first application programming interface layer when requested.
12. The computer implemented data structure and architecture of clause 10, wherein the reference module is configured to receive updated reference attributes from the process module, and is further configured to send these to the first data layer, optionally the reference data layer, to update the reference attributes stored therein.
13. The computer implemented data structure and architecture of any preceding clause dependent upon clause 6, wherein the second data store comprises an historic process parameter value, optionally wherein a process parameter value is sent to the second data store when the process parameter value is no longer associated with an active process, and therein said process value becomes a historic process parameter value, optionally wherein the second data layer further comprises a reporting database which further comprises one or more reports and is configured to provide reports to the second logic layer, optionally wherein the second logic layer comprises a reporting module, wherein the reporting module is configured to receive historic process parameter values from the second data store, transform them into one or more reports, and store one or more reports in reporting database, and is configured to receive reports from the reporting database, and is further configured to provide reports to the second application programming interface layer.
14. The computer implemented data structure and architecture of clause 13, wherein the second logic layer comprises a historical data services module, wherein the historical data services module is configured to receive historic process parameter values from the second data store, optionally when dependent on clause 8 or any clause dependent thereon, wherein the historical data services module is configured to provide historic process parameter values from the second data store to the process module when requested, optionally wherein the historical data services module is configured to provide the second application programming interface layer with historic process parameter values.
15. The computer implemented data structure and architecture of any preceding clause dependent upon clause 8, wherein the process module is configured to receive process parameter values from the first data layer, optionally from the process data layer; and/or when dependent upon clause 8, wherein the process module is configured to receive reference attributes from the reference module.
16. The computer implemented data structure and architecture of any preceding clause dependent on clauses 8 and 14, wherein the process module is configured to receive historic process parameter values from the historical data services module and/or directly from the second data store.
17. The computer implemented data structure and architecture of any preceding clause when dependent on clause 8, wherein the process module is configured to receive input data, representing inputs from users or external systems, from the first application programming interface layer.
18. The computer implemented data structure and architecture of any of clauses 15, 16 or 17, wherein the process module is configured to send the received data to a second process module; and/or wherein the second process module is configured to request data from the first process module.
19. The computer implemented data structure and architecture of clauses 15 to 18, wherein the process module is configured to determine from requested and or received data new values for reference attributes and/or process parameters and/or next actions and to provide these to the first application programming interface layer.
20. The computer implemented data structure and architecture of any preceding clause, wherein a reference attribute corresponds to a value of one of: a product, a measurement, or a quantity variable, in the system monitored and controlled by the computer.
21. The computer implemented data structure and architecture of any clause dependent upon clause 13, wherein a report is an aggregated view of the historic process parameter values.
22. The computer implemented data structure and architecture of any preceding clause, wherein the process module is configured to determine updated reference attributes and send these to the reference module, and/or wherein the process module is configured to determine updated process parameter values and send these to the first data layer or process data layer, optionally wherein the reference module is the reference module from which the reference value originated; and/or when dependent on clause 8, wherein the process module further comprises internal values which store new data derived from data provided to the process module such as reference attributes from a reference module and/or process parameter from a process module, and said internal value in turn is configured to be used by the process module to determine the new/updated reference attribute and/or action.
23. The computer implemented data structure and architecture of any preceding clause, wherein a plurality of process modules and a plurality of reference modules are split into units of functionality, optionally wherein each unit of functionality of the first architecture portion interacts separately with the second architecture portion, optionally wherein each unit of functionality of the first architecture portion comprises a segregated portion of the first architecture portion, further optionally wherein each unit of functionality is configured to request/read data from another unit of functionality, and/or wherein one unit of functionality can only read data from another unit of functionality, optionally wherein a process module in first unit of functionality can only write/update a value of a reference attribute associated with a reference module in the same unit of functionality.
24. The modular architecture of any preceding clause, wherein the first architecture portion is configured to manage present data and recently past data that represents ongoing activities within the system; and/or wherein the reference module is passive and reactively handles requests to read and write reference attributes, optionally wherein the reference module does not initiate behaviour; and/or wherein the mutable data comprises present data, and the immutable data comprises past data, optionally wherein present data comprises both present data, and recent past data still reflecting ongoing activities within the system.

The above embodiments are to be understood as illustrative examples. Further embodiments are also envisaged. It is to be understood that any feature described in relation to any one embodiment may be used alone, or in combination with other features described and may also be used in combination with one or more features of any other of the embodiments, or any combination of any other of the embodiments.

Furthermore, equivalents and modifications not described above may also be employed without departing from the scope of the invention, which is defined in the accompanying claims.

What is claimed is:

1. A computer implemented data structure and architecture for managing a first data store and a second data store, and for processing this data for purposes of monitoring and controlling a system in real time based on this data, wherein the first data store comprises mutable data, and the second data store comprises immutable data, the data structure and architecture comprising:
a first architecture portion configured for management of the first data store; and
a second architecture portion configured for management of the second data store, wherein:
the first architecture portion and second architecture portion are functionally linked so that the immutable data is configured to be provided to the first architecture portion when requested;
the first architecture portion comprises a first data layer comprising the first data store, a first logic layer, and a first application programming interface layer;
the first data store comprises one or more reference attributes whose values reflect a current state of variables within the system;
the first data store further comprises one or more process parameters whose values reflect ongoing processes within the system;
both the one or more reference attributes and the one or more process parameters comprise the mutable data;
the first architecture portion is configured to output process parameter values of complete processes to the second data store;
the first logic layer is configured to request the mutable data from the first data store and to request the immutable data from the second architecture portion;
the first logic layer is configured to at least one of:
process at least one of the mutable data or the immutable data to determine updated values for reference attributes; or
process at least one of parameters or new actions of the system, and wherein the processing is configured to be parameterised on a basis of the one or more process parameters;
the first architecture portion is then configured to at least one of:
store at least one of the updated values for reference attributes or process parameters in the first data store; and
output at least one of updated values of reference attributes or process parameters or new actions of the system to the first application programming interface layer.

2. The computer implemented data structure and architecture of claim 1, wherein the second architecture portion comprises a second data layer comprising:
the second data store;
a second logic layer; and
a second application programming interface layer.

3. The computer implemented data structure and architecture of claim 2, wherein the second data store comprises an historic process parameter value, wherein a process parameter value is sent to the second data store when the process parameter value is no longer associated with an active process, and therein a process value becomes a historic process parameter value, wherein:
the second data layer further comprises a reporting database which further comprises one or more reports and is configured to provide the one or more reports to the second logic layer; and
the second logic layer comprises a reporting module configured to receive historic process parameter values from the second data store, transform them into the one or more reports, store the one or more reports in the reporting database, receive the one or more reports from the reporting database, and provide the one or more reports to the second application programming interface layer.

4. The computer implemented data structure and architecture of claim 3, wherein a report is an aggregated view of the historic process parameter values.

5. The computer implemented data structure and architecture of claim 3, wherein the first architecture portion comprises:
a first section relating to reference data; and
a second section relating to process data that is relevant to ongoing processes within the system.

6. The computer implemented data structure and architecture of claim 5, wherein the first section of the first architecture portion comprises:
a reference data layer;
a reference logic layer; and
the first application programming interface layer; and
wherein the second section of the first architecture portion comprises:
a process data layer;
a process logic layer; and
the first application programming interface layer.

7. The computer implemented data structure and architecture of claim 6, wherein:
the first data layer comprises the reference data layer and the process data layer; and
the first logic layer comprises the reference logic layer and the process logic layer.

8. The computer implemented data structure and architecture of claim 7, wherein at least one of the first logic layer or reference logic layer comprises a reference module.

9. The computer implemented data structure and architecture of claim 8, wherein the reference module is configured to request one or more reference attributes from at least one of the first data layer or the reference data layer.

10. The computer implemented data structure and architecture of claim 9, wherein at least one of the first logic layer or a process logic layer comprises a process module.

11. The computer implemented data structure and architecture of claim 10, wherein a reference module is configured to provide reference values to a process module when requested.

12. The computer implemented data structure and architecture of claim 11, wherein the reference module is configured to provide reference attributes to the first application programming interface layer when requested.

13. The computer implemented data structure and architecture of claim 12, wherein the reference module is configured to:
receive updated reference attributes from the process module; and
send the updated reference attributes to at least one of the first data layer or a reference data layer to update the reference attributes stored therein.

14. The computer implemented data structure and architecture of claim 13, wherein the reference module is passive and reactively handles requests to read and write reference attributes, and wherein the reference module does not initiate behaviour.

15. The computer implemented data structure and architecture of claim 10, wherein the second logic layer comprises a historical data services module configured to receive historic process parameter values from the second data store, wherein:
the historical data services module is configured to provide historic process parameter values from the second data store to a process module when requested; and
the historical data services module is configured to provide the second application programming interface layer with the historic process parameter values.

16. The computer implemented data structure and architecture of claim 14, wherein the process module is configured to receive process parameter values from at least one of the first data layer or a process data layer, and wherein the process module is configured to receive reference attributes from a reference module.

17. The computer implemented data structure and architecture of claim 14, wherein the process module is configured to receive historic process parameter values from at least one of a historical data services module or directly from the second data store.

18. The computer implemented data structure and architecture of claim 14, wherein the process module is configured to receive input data, representing inputs from users or external systems, from the first application programming interface layer.

19. The computer implemented data structure and architecture of any of claim 14, wherein the process module is configured to at least one of:
send received data to a second process module; or
request data from the second process module.

20. The computer implemented data structure and architecture of claim 14, wherein the process module is configured to at least one of (1) determine, from received data, new values for reference attributes or (2) process at least one of parameters or next actions and to provide at least one of the parameters or the next actions to the first application programming interface layer.

21. The computer implemented data structure and architecture of claim 14, wherein a process module is configured to at least one of:
determine updated reference attributes;
send the updated reference attributes to a reference module;
determine updated process parameter values; and
send the updated process parameter values to at least one of the first data layer or a process data layer, wherein the reference module is the reference module from which a reference value originated, and wherein the process module further comprises internal values which store new data derived from data provided to the process module such as at least one of reference attributes from a reference module or process parameters from a process module, and an internal value in turn is configured to be used by the process module to determine at least one of an updated reference attribute or an action.

22. The computer implemented data structure and architecture of claim 14, wherein a plurality of process modules and a plurality of reference modules are split into units of functionality, wherein:
each unit of functionality of the first architecture portion interacts separately with the second architecture portion;
each unit of functionality of the first architecture portion comprises a segregated portion of the first architecture portion; and
each unit of functionality is configured to at least one of request or read data from another unit of functionality, wherein one unit of functionality can only read data from another unit of functionality, wherein a process module in a first unit of functionality can only write or update a value of a reference attribute associated with a reference module in a corresponding unit of functionality.

23. The computer implemented data structure and architecture of claim 1, wherein the first logic layer is configured to receive input data, representing inputs from users or external systems, from the first application programming interface layer.

24. The computer implemented data structure and architecture of claim 1, wherein a reference attribute corresponds to a value of one of:
a product;
a measurement; or
a quantity variable.

25. The computer implemented data structure and architecture of claim 1, wherein:
the data structure and architecture comprises a modular architecture;
the first architecture portion is configured to manage present data and recently past data that represents ongoing activities within the system;
the mutable data comprises present data, and the immutable data comprises past data; and
present data comprises both present data and recent past data still reflecting ongoing activities within the system.
